(19) United States
(12) Patent Application Publication
(10) Pub. No.: US 2009/0290098 A1
(43) Pub. Date: Nov. 26, 2009

(54) REFLECTION SHEET FOR BACKLIGHT OF LIQUID CRYSTAL DISPLAY DEVICE, AND BACKLIGHT OF LIQUID CRYSTAL DISPLAY DEVICE USING THE REFLECTION SHEET

(75) Inventor: Satoshi Ogawa, Nagasaki (JP)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: TSUJIDEN CO., LTD., Tokyo (JP)

(21) Appl. No.: 11/917,478

(22) PCT Filed: Jun. 13, 2006
(86) PCT No.: PCT/JP2006/311839

§ 371 Date: Dec. 13, 2007

(30) Foreign Application Priority Data
Jun. 13, 2005 (JP) 2005-173056

(51) Int. Cl. G02F 1/13357

(52) U.S. Cl. 349/67

(57) ABSTRACT

The present invention provides a reflection sheet that is used together with a prismatic light guide plate for the backlight of a liquid crystal display device, wherein the reflection sheet makes it possible to create a liquid crystal display device that has high brightness as well as few bright lines, bright spots, and brightness defects (moiré), that possesses improved resistance to damage on the prismatic light guide plate and reflection sheet, and that can preserve high brightness over a long period of time; and provides a backlight in which such reflection sheet is used. In the present invention a prism layer is formed on one surface of a reflection sheet, the vertex angle of the prisms is 145° or greater and 168° or less, and the distance between the vertices of the prisms on the reflection sheet is 50 μm or greater and 550 μm or less. The reflection sheet is arranged in such a way that the prism array direction of the reflection sheet makes an angle of 5° or greater and 20° or less with respect to the prism array direction of the prismatic light guide plate.

### TECHNICAL FIELD

The present invention relates to a reflection sheet that is used with a prismatic light guide plate for the backlight of a liquid crystal display device, and to the backlight of a liquid crystal display device using the reflection sheet.

### BACKGROUND ART

Liquid crystal display devices are in wide use in mobile phones, digital cameras, personal computers, office automation equipment, and the like. Light weight, reduced thickness, and reduced power consumption are in particular demand for display devices for use in mobile equipment. Further improvement of uniformity and display quality, and improved reliability of backlights are in demand due to improvements in the display quality of liquid crystals. Television picture display has recently come into demand in laptop computers as well, and high brightness and improved display quality and durability of display devices are in particular demand.

White resin reflection sheets compounded with white pigment, and reflections sheets obtained by sputtering, vapor depositing, or otherwise applying a film layer composed of silver, aluminum, or another metal having high specular reflection on such a white resin reflection sheet are coming into wide use in order to address these problems. However, a reflection sheet provided with a film layer composed of silver, aluminum, or another metal having high specular reflection reflects light as a mirror, so that there are such problems as that light interference readily develops and defects in backlight are easily perceived as bright lines or bright spots.

While addressing these problems, reflection sheets having a minutely concavo-convex layer formed on a surface (JP-A 2004-69867), reflection sheets in which a smooth surface is integrally formed on a surface having a layer provided with protrusions (JP-A 2004-252383), and embossed reflection sheets (JP-A 2005-319588), (JP-A 2001-266629) have been proposed in order to improve the brightness and reduce the brightness defects (moiré) of a backlight. However, reflection sheets provided with a minutely concavo-convex layer, reflection sheets in which a smooth surface is integrally formed on a surface having a layer provided with protrusions, and embossed reflection sheets are configured so that a light guide plate is supported by points provided by protrusions, convex portions, or other points that still generate brightness defects (moiré). Therefore, there are problems in that the light guide plate and the reflection sheet are damaged by the vibration and the like of the reflection sheet disposed underneath the light guide plate, accompanied by the generation of bright lines or bright spots.

Patent Document 1: JP-A 2004-69867

Patent Document 2: JP-A 2004-252383

Patent Document 3: JP-A 2005-319588

Patent Document 4: JP-A 2001-266629

### DISCLOSURE OF THE INVENTION

### Problems to Be Solved by the Invention

An object of the present invention is to provide a reflection sheet that is used together with a prismatic light guide plate for the backlight of a liquid crystal display device, wherein the reflection sheet makes it possible to create a liquid crystal display device that has high brightness and high uniformity of light as well as few bright lines, bright spots, and brightness defects, that possesses improved resistance to damage in the prismatic light guide plate and reflection sheet, and that can preserve the high brightness over a long period of time; and to provide a backlight for a liquid crystal display device in which said reflection sheet is used.

### Means Used to Solve the Above-Mentioned Problems

The main point of the present invention is a reflection sheet being used together with a prismatic light guide plate for a backlight of a liquid crystal display device, a prism layer is formed on one surface of the reflection sheet. The prisms of the reflection sheet are configured so that the vertex angle of the prisms is 145° or greater and 168° or less, and the distance between the vertices of the prisms on the reflection sheet (distance between an apex of a cross section of a prism on the reflection sheet and an apex of a cross section of an adjacent prism) is 50 μm or greater and 550 μm or less.

The reflection sheet of the present invention comprises at least a prism layer, a resin sheet layer, and a metal film layer. An anticorrosive layer and an adhesive layer can also be optionally provided, when needed, and an adhesive agent layer and a resin sheet layer can be further provided.

Furthermore, the backlight of the liquid crystal display device is characterized in that the reflection sheet of the present invention is disposed so that the prism array direction of the reflection sheet are arranged at an angle of 5° or greater and 20° or less in relation to the prism array direction of the prismatic light guide plate.

### EFFECT OF THE INVENTION

Using the reflection sheet of the present invention provides an effect wherein a liquid crystal display device can be achieved that has high uniformity of light, few bright lines, bright spots, and brightness defects (moiré); possesses improved resistance to damage in the prismatic light guide plate and reflection sheet; and can maintain high brightness over a long period of time while maintaining the high brightness that can be achieved by specular reflection and the like.

### BRIEF DESCRIPTION OF THE DRAWINGS

FIG. 1 is a diagram schematically showing an example of a configuration of a backlight in a sidelight-type liquid crystal display device;

FIG. 2 is a diagram schematically showing a prism layer of a reflection sheet;

FIG. 3 is a diagram schematically showing the shapes of ridgelines made by the vertices of the reflection sheet;

FIG. 4 is a diagram schematically showing a configuration example of the reflection sheet;

FIG. 5 is a diagram schematically showing another configuration example of the reflection sheet;

FIG. 6 is a diagram showing an apparatus for measuring GPL friction properties;

FIG. 7 is a diagram showing an apparatus for carrying out a Bogo test; and

FIG. 8 is a diagram illustrating the angles at which the prism array direction of the reflection sheet are arranged in relation to the prism array direction of the prismatic light guide plate.

### DESCRIPTION OF THE NUMERICAL SYMBOLS

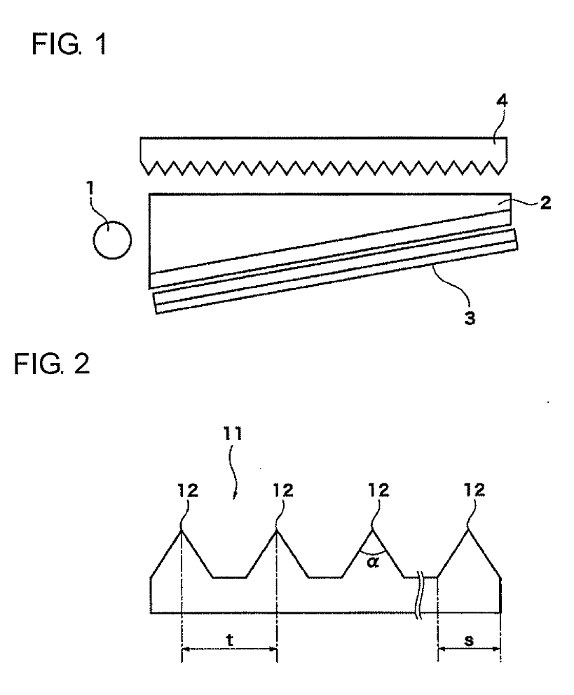

1: Lamp
2: Prismatic light guide plate
3: Reflection sheet
4: Prism lens sheet
5: Prism array direction of reflection sheet
6: Prism array direction of prismatic light guide plate
11: Prism layer of reflection sheet
12: Prism apex
21: Reflection sheet
22: Prism layer
23: Anticorrosive layer
24: Metal film layer
25: Adhesive layer
26: Resin sheet layer
27: Adhesive agent layer
28: Resin sheet layer
29: Transparent resin sheet layer
30: Apparatus for measuring GPL friction properties intended to keep the amount of light constant and the brightness uniform as much as possible. The prism array direction of the prismatic light guide plate 2 in FIG. 1 is aligned with (parallel to) the incidence direction of light and is disposed perpendicularly to the prism array direction of the prism lens sheet 4.

The present invention is a reflection sheet 3 that is used together with the prismatic light guide plate 2 for the backlight of the liquid crystal display device, wherein a prism layer is formed on one side of the reflection sheet 3. One example of the shape of the prism layer of the reflection sheet is shown in FIG. 2 and is characterized in that the vertex angle α of a prism is 145° or greater and 168° or less, and that the distance t between the vertices of the prisms of the reflection sheet 3 (distance between an apex of a cross section of a prism on the reflection sheet and an apex of a cross section of an adjacent prism) is 50 to 550 μm. It is preferable herein that all the vertex angles of the prisms of the reflection sheet be kept the same, and that the distance between the vertices of the prisms also be made the same between all the vertices.

A prism layer 11 of a reflection sheet is schematically shown in FIG. 2. The angle of a prism apex 12, i.e., the vertex angle, is indicated by the symbol α. The distance between the vertices of the prisms in FIG. 2, i.e., the distance between an apex of a cross section of a prism on the reflection sheet and an apex of a cross section of an adjacent prism is indicated by the letter t. The shape of the reflection sheet of the present invention is characterized in that the vertex angle α of a cross section of a prism is 145° or greater and 168° or less, and the distance t between an apex of a prism and an apex of an adjacent prism, i.e., the distance between the vertices of the prisms, is 50 μm or greater and 550 μm or less. The prisms on the reflection sheet are configured so that the vertex angles are 145° or greater and 168° or less, and the distance between the vertices of the prisms is set to 50 μm or greater and 550 μm or less, as shown in example 1. The resulting effect is that a liquid crystal display device can be achieved that has high uniformity of light as well as few bright lines, bright spots, and brightness defects (moiré); possesses improved resistance to damage in the prismatic light guide plate and reflection sheet; and can maintain high brightness over a long period of time while maintaining the high brightness that can be achieved by specular reflection and the like.

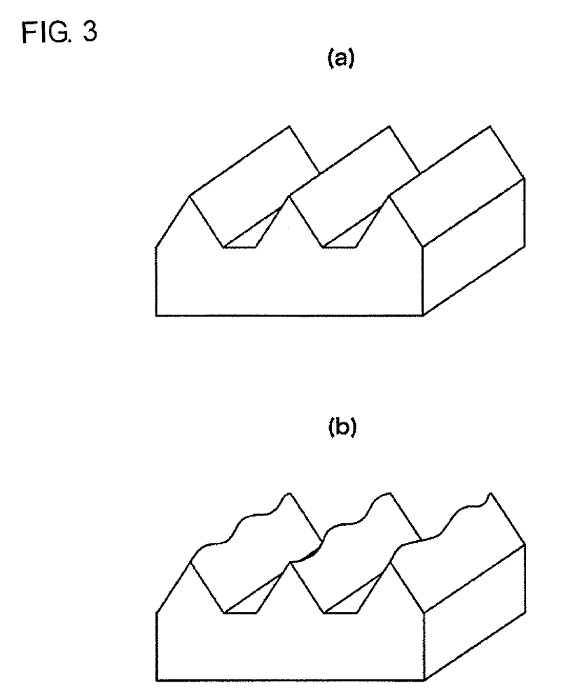

The reflection sheet of the present invention may be a reflection sheet in which the shape of the ridgelines made by the vertices of the prisms is a straight line, curved line, or wavy line. FIG. 3(a) shows a case in which the shape of the ridgelines made by the vertices of the prisms of the reflection sheet is a straight line, and FIG. 3(b) shows a case in which the planar shape of the ridgelines made by the vertices of the prisms of the reflection sheet is a curved or wavy line. The vertical height of the ridgelines formed by the vertices of the prisms in this case remains the same irrespective of the planar shape.

The reflection sheet of the present invention has a resin sheet as a substrate, and a prism layer is mounted thereon, and a metal film layer can be further provided. In other words, a film layer of silver, aluminum, or another metal having high specular reflection can be provided by sputtering, vapor deposition, or another method. The metal film layers in wide use are preferably metal layers primarily composed of silver, aluminum, and another metal having a maximum reflectivity in the visible-light region.

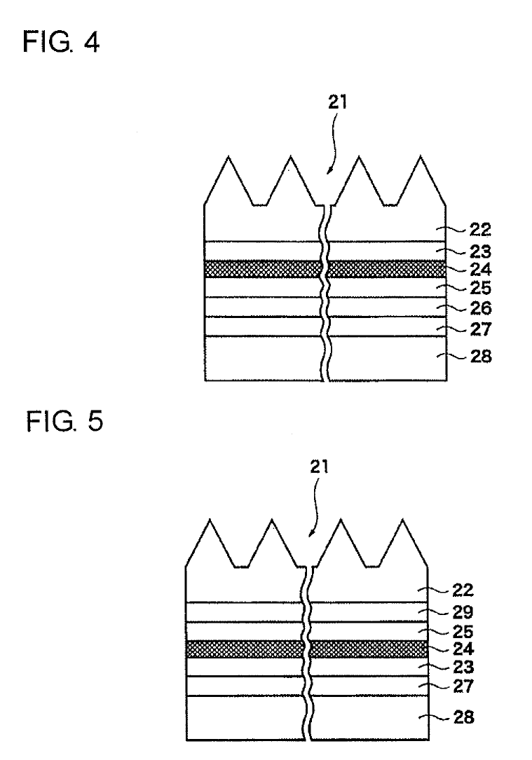

The reflection sheet of the present invention is substantially a reflection sheet in which a prism layer is provided on a resin sheet. In practice, a metal film layer, an optional adhesive layer and anticorrosive layer, and also an adhesive agent layer and an additional resin sheet layer can be provided in addition to the prism layer. A specific example of a configuration of the reflection sheet is shown in FIG. 4. In other words, a reflection sheet 21 includes a prism layer 22, an anticorrosive layer 23, a specularly reflective metal film layer 24, an adhesive layer 25, and a resin sheet layer 26 stacked from above in the foregoing order. An adhesive layer 27 and a resin sheet layer 28 can be further provided underneath the resin sheet layer 26 in the foregoing configuration. The shape stability of the reflection sheet can be enhanced by providing the adhesive layer 27 and the resin sheet layer 28. The resin sheet layer 26 and resin sheet layer 28 may be transparent resin sheets, or may be white resin sheet layers that contain a white pigment. The white resin sheet preferably has a reflectivity of 90% or greater and possesses diffuse reflection characteristics. The pigment may contain pigments other than a white pigment. The prism layer 22 has a prism vertex angle of 145° or greater and 168° or less, as previously stated. The distance between a prism apex and another prism apex adjacent thereto is 50 μm or greater and 550 μm or less. FIG. 4 is drawn longer in the vertical direction than in reality in order to show the configuration of the reflection sheet.

Another example of a specific configuration of the reflection sheet of the present invention is shown in FIG. 5. In other words, a reflection sheet 21 includes a prism layer 22, a transparent resin sheet layer 29, an adhesive layer 25, a specularly reflective metal film layer 24, and an anticorrosive layer 23 stacked from above in the foregoing order. An adhesive layer 27 and a resin sheet layer 28 can be further provided underneath the anticorrosive layer 23 in the foregoing configuration. The shape stability of the reflection sheet can be enhanced by providing the adhesive layer 27 and the resin sheet layer 28. The resin sheet layer 28 may be a transparent resin sheet, or may be a white resin sheet layer that contains a white pigment. The white resin sheet preferably has a reflectivity of 90% or greater and possesses diffuse reflection characteristics. The pigment may contain pigments other than a white pigment. The prism layer 22 has a prism vertex angle of 145° or greater and 168° or less in the same manner as in the example shown in FIG. 4. The distance between a prism apex and another prism apex adjacent thereto is 50 μm or greater and 550 μm or less. FIG. 5 is drawn longer in the vertical direction than in reality in order to show the configuration of the reflection sheet.

The specularly reflective metal film layer is closely affected by the degree to which the layer adheres to the resin sheet layer and is sometimes modified by the aggregation, oxidation, sulfidation, chloridation, or another change in silver or other metals, resulting in reduced reflectivity. The anticorrosive layer 23 is provided in order to prevent the reduction in reflectivity based on a modification of the metal film layer. Materials having low oxygen permeability and moisture permeability are preferably used for the anticorrosive layer 23 and the adhesive layer 25.

The resin sheet used as a substrate for the reflection sheet of the present invention can be composed of a variety of resins. Examples of such resins include polyester resin such as polyethylene terephthalate and polyethylene naphthalate, vinylidene resin such as polyvinylidene chloride; polyolefin resin such as polyethylene; polycarbonate resin such as bisphenol A polycarbonate; and polyethersulfone and the like. However, it is not necessarily limited to these resins, and any resin having a high glass transition point and melting point can be appropriately used. A sheet produced by biaxial stretching is more preferred.

The reflection sheet of the present invention is used together with the prismatic light guide plate, but it is preferable to dispose the reflection sheet so that the angle formed by the prism array direction of the reflection sheet in relation to the prism array direction or the light incidence direction of the prismatic light guide plate is 5° or greater and 20° or less. In particular, brightness defects (moiré) can be reduced by disposing the reflection sheet of the present invention in the foregoing manner. The brightness defects (moiré) of the backlight cannot be removed when the angle is less than 5°, and although the brightness defects (moiré) can be reduced when the angle exceeds 20°, such an angle is still not preferred because of reduced brightness.

The angle at which the prism array direction of the reflection sheet is arranged in relation to the prism array direction of the prismatic light guide plate is described with reference to FIG. 8. FIG. 8 is a diagram in which the prismatic light guide plate 2 is partially cut away, and parts of the reflection sheet and the prismatic light guide plate are shown in alignment with the reflection sheet 3 disposed underneath the plate. FIG. 8 shows a ridgeline 6 formed by the prism vertices of the prismatic light guide plate 2, i.e., the prism array direction of the prismatic light guide plate, as well as a ridgeline 5 formed by the prism vertices of the reflection sheet 3, i.e., the prism array direction of the reflection sheet. The angle at which the prism array direction of the reflection sheet is arranged relative to the prism array direction of the prismatic light guide plate 2 is indicated by the symbol θ in FIG. 8. The present invention is characterized in that the reflection sheet is disposed so that the angle θ is 5° or greater and 20° or less.

The present invention is more specifically described below based on examples. However, the present invention is not limited to these examples.

Methods for Evaluating Evaluation Items

1. GPL Friction Properties

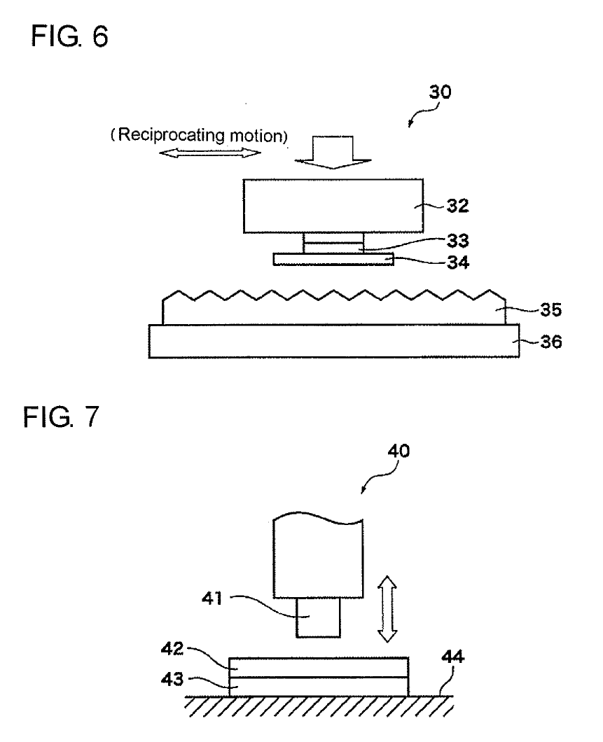

Measurement is performed using a measuring apparatus such as the one shown in FIG. 6.

A sample (reflection sheet) is cut into pieces, each being in a shape of 2 cm squares and is secured by double-sided tape so that the reflection surface of the reflection sheet is on the side that is rubbed against a test jig 32 (the surface of the reflection sheet provided with the prisms faces toward the prismatic light guide plate). The prism surface of the prismatic light guide plate 35 is arranged to face upward (toward the surface of the reflection sheet), and the prismatic light guide plate 35 is mounted on a flat measurement stand 36. A 700 g load is applied on the test jig 32 so that the prism surface of the prismatic light guide plate 35 and the prism surface of the reflection sheet (sample) are made to rub against each other. The test jig 32 is made to perform a reciprocating motion 2 cm to the left and right ten times, and the prismatic light guide plate and the reflection sheet are observed to see whether they are damaged or not.

2. Bogo Test

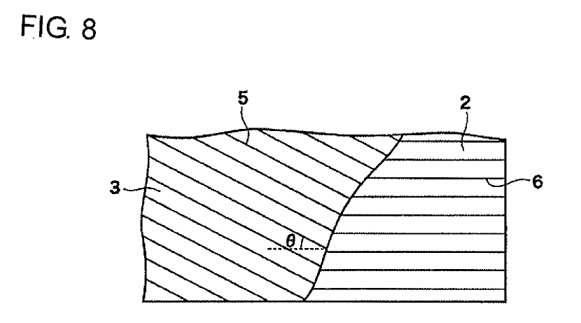

Measurement was performed using a measuring apparatus such as the one shown in FIG. 7.

A prismatic light guide plate 43 whose prism surface faces upward is placed on a flat board, and a reflection sheet 42 is further mounted thereupon so that the prism surface faces the prism surface of the prismatic light guide plate 43. The reflection sheet 42 is struck 1000 times from above the reflection sheet 42 with a pressure part 41 that is composed of a metal tip 1 cm square and that is moved a distance of 4 cm at a speed of 130 strokes per minute under a load of 2 kg/cm². This measures the ease with which the reflection sheet of a backlight for a liquid crystal can be damaged (damage properties) by being brought into contact with a prismatic light guide plate.

3. Method for Measuring Relative Brightness

A color brightness meter manufactured by Topcon Corporation (product number: BM-7) was used to measure relative brightness. In other words, the relative brightness of a conventional white reflection sheet and a reflection sheet of a measurement certificate in is measured at a backlight for a liquid crystal, and relative brightness is measured in relation to the white reflection sheet.

4. Moiré Evaluation Method

The back surface (surface without any emitting light) of a backlight for a liquid crystal provided with a reflection sheet is brought into contact, and the resulting interference pattern of light is visually compared. The results are compared with those for a white reflection sheet, the superiority or inferiority of the brightness defects is observed, and a passing grade is given if the result is the same as that for the white reflection sheet.

Method for Measuring the Distance Between Prisms and the Prism Vertex Angle

The distance between the prisms and the prism vertex angle of a sheet having prisms is measured in the following manner. An ultra-deep shape measuring microscope manufactured by Keyence Corporation (VK-8500) is used as the measuring instrument.

1. Method for Measuring Prism Vertex Angle

Measurement is performed using a 50× objective lens at a measuring pitch of 0.1 μm. A profile is selected from the top menu on the measurement screen, and a measurement perpendicular to the prism formation direction of the sheet having the prisms is selected, whereupon the irregularities on the measurement surface are displayed. The cursor is placed on the highest and lowest points of the prism portion displayed. The angle from the lowest point of a prism to the highest point can be measured by a measuring instrument. This measurement is performed to the right and left of the prism; a combined value is calculated; the formula A=(180°−Lens vertex angle) is used, where A is the measurement value; and the lens vertex angle is measured.

2. Method for Measuring the Interval Between Prisms

Measurement is performed using a 50× objective lens at a measuring pitch of 0.1 μm. A profile is selected from the top menu on the measurement screen, and a measurement perpendicular to the prism formation direction of the sheet having the prisms is selected, whereupon the irregularities on the measurement surface are displayed. The interval between prisms can be automatically measured by placing the cursor over an apex of a prism and over the apex of an adjacent prism.

### Example 1

A polyester film (A4300 manufactured by Toyobo, thickness: 125 μm) was used as a substrate (resin sheet layer 26 in FIG. 4), an adhesive layer 25 (thickness: 3 μm) was applied to the film, a metal film layer 24 (silver, thickness: 120 nm) was further formed on the layer by vacuum vapor deposition, a nitrocellulose solution was applied to the metal film layer 24 to form an anticorrosive layer 23 (thickness: 1 μm), a prism layer 22 was further produced on top of the anticorrosive layer 24 by using electron beam curing resin, and a reflection sheet 21 was produced. An electron beam curing resin was placed on top of the anticorrosive layer 24, a metal die was placed on the resin to form a prism shape, and the resin was irradiated with an electron beam through the substrate, forming the prism layer. The prism layer was provided with variable prism vertex angles and variable distances from an apex of a prism to the apex of an adjacent prism, as shown in Table 1.

The resulting reflection sheet having variable prism vertex angles and variable distances between prism apices was used to evaluate the performance of the reflection sheet in terms of GPL friction properties, Bogo tests, relative brightness, and brightness defects (moiré). The GPL friction properties and Bogo tests were evaluated using a special measuring apparatus, and brightness and brightness defects were evaluated by incorporating the reflection sheet into a liquid crystal display device. The prism lens sheet in the liquid crystal display device was brought into contact with the prismatic light guide plate such that the prism surface faced downward, the prism array direction was perpendicular to the incidence direction of light, the prismatic light guide plate was brought into contact with the prism surface of the reflection sheet such that the prism surface of the plate faced downward, and the prism array direction of the prismatic light guide plate was aligned with the direction of incidence light (perpendicular to the prism array direction of the prism lens sheet). The reflection sheet was arranged in such a way that the prism array direction of the reflection sheet formed an angle of 5° in relation to the prism array direction of the prismatic light guide plate. The prism lens sheet and prismatic light guide plate used were those having a prism vertex angle of 90°.

The results of the evaluation are shown in Table 1. The prism vertex angles are the angles shown by the symbol α in FIG. 2 and are measured in degrees. The distance between prism vertices is shown by a letter t in FIG. 2 and is measured in micrometers. The length of the base of the triangular shaped portion of a prism is shown by a letter s in FIG. 2 and remained constant at 50 μm in all cases. The GPL friction properties are an indicator showing how damage or scars are inflicted or made by the friction between the light guide body and the reflection sheet. The indicator improves in the sequence x, Δ, ◯. The Bogo test is an indicator showing how damage or scars are inflicted or made when the light guide body and reflection sheet are stacked together, followed by being struck from above. The indicator improves in the sequence x, Δ, ◯. The relative brightness is determined by assuming that a brightness of 100 is achieved when a white resin sheet is used for the prism layer. The brightness defects (moiré) is abated in the sequence x, Δ, ◯, ⊚.

TABLE 1

| Prism | Prism apex | | | | Brightness |
|---|---|---|---|---|---|
| vertex angle | distance | GPL friction | Bogo | Relative | defects |
| (°) | (μm) | properties | test | brightness | (moiré) |
| 90 | 50 | X | X | 107 | ⊚ |
| 90 | 165 | X | X | 110 | ◯ |
| 90 | 400 | X | X | 118 | ◯ |
| 140 | 165 | X | X | 104 | ◯ |
| 140 | 333 | X | X | 115 | ◯ |
| 145 | 50 | ◯ | ◯ | 108 | ⊚ |
| 165 | 50 | ◯ | ◯ | 116 | ⊚ |
| 165 | 400 | ◯ | ◯ | 120 | ◯ |
| 165 | 800 | Δ | Δ | 122 | Δ |
| 168 | 550 | ◯ | ◯ | 120 | Δ |
| No prism | | ◯ | ◯ | 130 | X |

A reflection sheet having a transparent resin layer that does not have prisms is best in terms of brightness only, but is worst in terms of brightness defects (moiré). It can be seen that brightness defects (moiré) are remarkably abated by forming prisms on the reflection sheet. The light guide body and the reflection sheet are resistant to damage, have few brightness defects, and possess a satisfactory relative brightness of about 120 when the prism vertex angle ranges from 145° to 168°. It can be seen from the foregoing that keeping the vertex angles of the prisms on the prism layer of the reflection sheet at 145° or greater and 168° or less is preferable from the standpoint of brightness, damage properties, and brightness defects. It can be also seen that when focus is made on the distance between a prism apex and an adjacent apex, keeping the distance in a range of 50 μm or greater and 550 μm or less is preferable from the standpoint of brightness, damage properties, and brightness defects. It can be seen that the GPL friction properties, Bogo tests, and relative brightness are unsatisfactory regardless of the distance between prism vertices when the prism vertex angle is 140° or less, but that the GPL friction properties, Bogo tests, and relative brightness are satisfactory when the prism vertex angle is 145° or greater and 168° or less. In addition, the GPL friction properties and the Bogo tests deteriorate somewhat when the prism vertex angle is 165° and the distance between prism vertices is 800 μm, but the GPL friction properties and the Bogo tests are satisfactory when the prism vertex angle is 168° and the distance between prism vertices is 550 μm. It can be seen from the foregoing that a light-type backlight reflection sheet in which the prism vertex angle is 145° to 168° and the distance between prism vertices is 50 μm to 550 μm is preferred from the standpoint of brightness, damage properties, and brightness defects.

### Example 2

A reflection sheet was subsequently manufactured in the same manner as in example 1. The sheet had a prism vertex angle of 145°, and the distance between the prism bases, indicated by a letter s in FIG. 2, was 50 μm. The reflection sheet was incorporated into a liquid crystal display device and evaluated together with the comparative example described below. The reflection sheet was arranged in the liquid crystal display device so as to vary the angle at which the prisms of the reflection sheet were arranged in relation to the prism array direction of the prismatic light guide plate. In addition, the prism lens sheet was brought into contact with the prismatic light guide plate such that the prism surface of the sheet faced downward, the prism lens sheet was arranged in such a way that the prism array direction of the sheet was perpendicular to the direction of incident light, the prismatic light guide plate was brought into contact with the prism surface of the reflection sheet such that the prism surface of the place faced downward, and the prismatic light guide plate was arranged in such a way that the prism array direction of the plate was aligned with the direction of incident light (perpendicular to the prism array direction of the prism lens sheet). The prism lens sheet and prismatic light guide plate used were those having a prism vertex angle of 90°.

Table 2 shows the relation of the angle to the brightness and brightness defects for a case of varying the angle at which the prisms of the reflection sheet are arranged in relation to the prism array direction of the prismatic light guide plate. It can be seen from Table 2 that brightness is high and brightness defects are minor when the angle ranges from 5° or greater to 20° or less. It can be also seen that brightness is low and brightness defects are major in a reflection sheet having particles of the comparative example.

TABLE 2

| Angle (°) | Brightness (cd/mm²) | Brightness defects |
|---|---|---|
| 0 | 2375 | X |
| 3 | 2376 | Δ |
| 5 | 2378 | ◯ |
| 10 | 2383 | ◯ |
| 20 | 2357 | ◯ |
| 30 | 2274 | ◯ |
| 45 | 2190 | ◯ |
| Comparative example | 2222 | x |

### Comparative Example

As a comparative example, a reflection sheet was manufactured in which an undercoat layer (thickness: 2 μm) was formed on a polyester film (A4300 manufactured by Toyobo; thickness: 125 μm), a metal film layer composed of silver (thickness: 100 nm) was diposited by vacuum vapor deposition, and a resin layer containing particles having an mean grain size of 4 μm being mixed therein was further formed by wet coating (thickness: 5 μm) on the film layer as a layer for preventing brightness nonuniformities.

### INDUSTRIAL APPLICABILITY

Use of the reflection sheet of the present invention can provide a liquid crystal display device that has high light uniformity as well as few bright lines, bright spots, and brightness defects (moiré); possesses improved resistance to damage on the light guide plate and reflection sheet; and can maintain high brightness over a long period of time while maintaining the high brightness achieved through specular reflection and the like. Liquid crystal display devices are in wide use not only in the industrial world but also as household and personal items, and the effects of the contribution of the present invention to the industrial world are extremely large.

1. A reflection sheet for a backlight of a liquid crystal display device, the reflection sheet being used together with a prismatic light guide plate for the backlight of a liquid crystal display device, wherein a prism layer is formed on one surface of the reflection sheet.

2. The reflection sheet for a backlight of a liquid crystal display device according to claim 1, wherein a vertex angle of a prism on the reflection sheet is 145° or greater and 168° or less.

3. The reflection sheet for a backlight of a liquid crystal display device according to claim 2, wherein the distance between the vertices of prisms on the reflection sheet is 50 μm to 550 μm.

4. The reflection sheet for a backlight of a liquid crystal display device according to claim 3, wherein the reflection sheet comprises at least a prism layer, a resin sheet layer, and a metal film layer.

5. A backlight of a liquid crystal display device wherein the reflection sheet according to claim 4 is disposed in such a way that the angle formed by the prism array direction of the reflection sheet with respect to the prism array direction of the prismatic light guide plate is between 5° and 20°.

6. The reflection sheet for a backlight of a liquid crystal display device according to claim 1, wherein the distance between the vertices of prisms on the reflection sheet is 50 μm to 550 μm.

7. The reflection sheet for a backlight of a liquid crystal display device according to claim 6, wherein the reflection sheet comprises at least a prism layer, a resin sheet layer, and a metal film layer.

8. A backlight of a liquid crystal display device wherein the reflection sheet according to claim 7 is disposed in such a way that the angle formed by the prism array direction of the reflection sheet with respect to the prism array direction of the prismatic light guide plate is between 5° and 20°.

9. The reflection sheet for a backlight of a liquid crystal display device according to claim 2, wherein the reflection sheet comprises at least a prism layer, a resin sheet layer, and a metal film layer.

10. A backlight of a liquid crystal display device wherein the reflection sheet according to claim 9 is disposed in such a way that the angle formed by the prism array direction of the reflection sheet with respect to the prism array direction of the prismatic light guide plate is between 5° and 20°.

11. A backlight of a liquid crystal display device wherein the reflection sheet according to claim 3 is disposed in such a way that the angle formed by the prism array direction of the reflection sheet with respect to the prism array direction of the prismatic light guide plate is between 5° and 20°.
